(19) United States
(12) Patent Application Publication
(10) Pub. No.: US 2009/0141712 A1
(43) Pub. Date: Jun. 4, 2009

(54) ROUTER DEVICE

(75) Inventor: Kouta Maeno, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/277,325

(22) Filed: Nov. 25, 2008

(30) Foreign Application Priority Data
Nov. 30, 2007 (JP) 2007-310640

(51) Int. Cl. H04L 12/56

(52) U.S. Cl. 370/389

(57) ABSTRACT

The present invention provides a router device capable of performing routing processing on each received packet at high speed by an IP routing accelerator without the interchange of transmission order of each packet in the same session. The router device registers a packet transmission destination and a session type obtained by analyzing each received packet in a transmission route information table in association with each other and at the same time transmits all received packets accumulated in a session-by-session transmission queue corresponding to the session type of the received packet.

### BACKGROUND OF THE INVENTION

The present invention relates to a router device having an IP routing accelerator function.

There has been widely known a router device which relays IP packets between communication networks. Normally, the router device determines a relay destination for a received packet, based on destination information or the like contained in each packet. An IP router device with a TCP terminating function, which extracts information about a connection destination of a TCP (Transmission Control Protocol) connection from an IP packet targeted for relay, rewrites or reprograms part of IP address information and port number information lying within the IP packet in accordance with a predetermined rule so as to form the TCP connection to the connection destination, and relays the IP packet, has been disclosed in, for example, a patent document 1 (Japanese Unexamined Patent Publication No. 2001-244957).

There is also known a router device equipped with an IP routing accelerator for performing routing processing on each packet that satisfies particular conditions at high speed. Such a router device is equipped with a routing information table in which sessions types and packet transmission destinations are registered with being associated with one another. When a session type obtained by analyzing a received packet is being registered in the routing information table, the IP routing accelerator transmits the received packet to its corresponding packet transmission destination corresponding to the session type. On the other hand, when the session type obtained by the analysis is not registered in the routing information table and the corresponding received packet satisfies a condition processable by the IP routing accelerator, the Ip routing accelerator newly sets a packet transmission destination and registers the packet transmission destination and the session type in the routing information table in association with each other.

In the router device equipped with the IP routing accelerator having the above configuration, however, there is a case in which when packet transmission destinations and session types are newly associated with one another and registered in the corresponding routing information table, a plurality of packets in the same session as a received packet remain unsent within the router device. A problem arises in that when each packet in the same session as communication sessions is received after packet transmission destinations and the communication sessions have been registered in the routing information table in association with one another and before the processing of transmission of all remaining packets is carried out, the IP routing accelerator transmits this received packet prior to the remaining packets, thereby causing the interchange of transmission order of each packet lying in the same session.

### SUMMARY OF THE INVENTION

The present invention has been made in view of the foregoing problems. It is an object of the present invention to provide a router device capable of performing routing processing on each received packet by an IP routing accelerator at high speed without causing the interchange of transmission order of each packet in the same session.

According to one aspect of the present invention, for attaining the above object, there is provided a router device comprising a transmission route information table for storing session types and packet transmission destinations therein in association with one another, an IP routing accelerator for, when it is discriminated that a session type of each received packet is being stored in the transmission route information table, transmitting the received packet to a corresponding packet transmission destination corresponding to the session type, and relaying the received packet to a subsequent stage when it is discriminated that the session type is not stored in the transmission route information table, a sequence control receiver for accumulating each received packet sent from the IP routing accelerator in each of session-by-session transmission queues each corresponding to the session type of the received packet, an IP routing processor for setting a packet transmission destination to the received packet, and a sequence control transmitter for causing the transmission route information table to store the packet transmission destination set to each received packet and the session type of the received packet in association with each other and causing the IP routing accelerator to transmit all received packets accumulated in the session-by-session transmission queue corresponding to the session type of the received packet.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram showing a router device along with communication networks;

FIG. 2 is a block diagram illustrating the router device in which a sequence controller is represented in detail;

FIG. 3 is a diagram showing transmission queues set according to sessions; and

FIG. 4 is a flowchart illustrating a packet routing processing routine.

### DETAILED DESCRIPTION OF THE PREFERRED EMBODIMENTS

A preferred embodiment according to the present invention will hereinafter be described in detail with reference to the accompanying drawings.

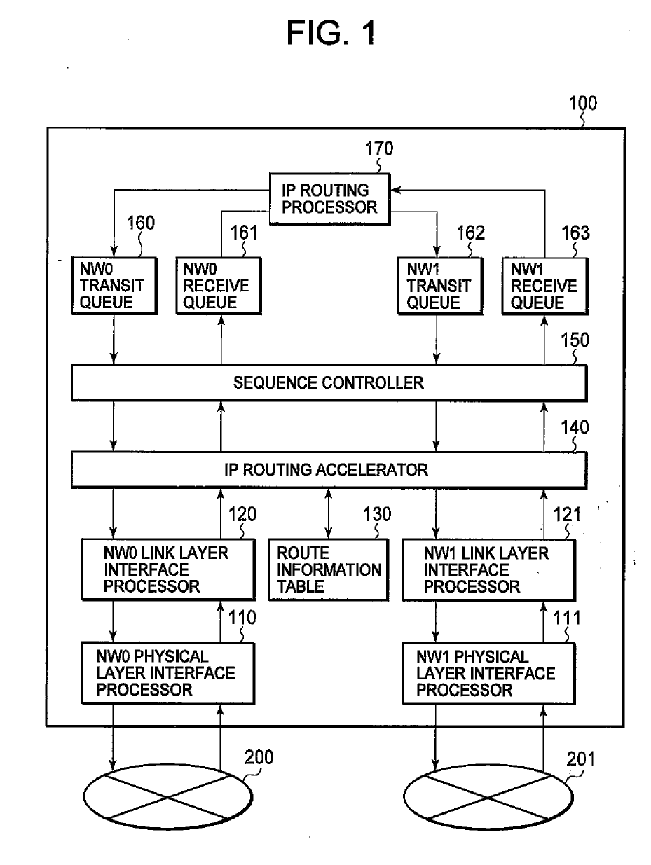

FIG. 1 is a block diagram showing a router device 100 according to the present invention along with communication networks 200 and 201 such as Internet. The router device 100 is of a device which relays packets between the communication networks 200 and 201. The router device 100 includes an NW0 physical layer interface processor 110, an NW1 physical layer interface processor 111, an NW0 link layer interface processor 120, an NW1 link layer interface processor 121, a transmission route information table 130, an IP routing accelerator 140, a sequence controller 150, an NW0 transmit queue 160, an NW0 receive queue 161, an NW1 transmit queue 162, and an NW1 receive queue 163 and an IP routing processor 170.

The NW0 physical layer interface processor 110 performs a process related to a physical layer of an OSI (Open Systems Interconnection) reference model established by International Organization for Standardization (ISO) on each packet received from the communication network 200 and gives the received packet to the NW0 link layer interface processor 120. The NW0 physical layer interface processor 110 performs the process related to the physical layer on a transmit packet given from the NW0 link layer interface processor 120 and transmits the same to the communication network 200. Likewise, the NW1 physical layer interface processor 111 performs the process related to the physical layer on each packet received from the communication network 201 and gives the received packet to the NW1 link layer interface processor 121. The NW1 physical layer interface processor 111 performs the process related to the physical layer on a transmit packet given from the NW1 link layer interface processor 121 and transmits the same to the communication network 201.

The NW0 link layer interface processor 120 effects a process related to a link layer of an OSI reference model on the received packet sent from the NW0 physical layer interface processor 110 and gives the same to the IP routing accelerator 140. The NW0 link layer interface processor 120 performs the process related to the link layer on a transmit packet from the IP routing accelerator 140 and gives the same to the NW0 physical layer interface processor 110. The NW1 link layer interface processor 121 performs the process related to the link layer of the OSI reference model on the received packet from the NW1 physical layer interface processor 111 and gives the same to the IP routing accelerator 140. The NW1 link layer interface processor 121 performs the process related to the link layer on a transmit packet from the IP routing accelerator 140 and gives the same to the NW1 physical layer interface processor 111.

The transmission route information table 130 stores session types and packet transmission destinations sent from a sequence control transmitter 152 to be described later therein in association with one another. The transmission route information table 130 is capable of storing correspondences between the session types and packet transmission destinations therein in plural form. The transmission route information table 130 stores unique identifiers and IP addresses for transmission destinations therein in association with one another every session type, for example.

The IP routing accelerator 140 analyzes the received packet sent from the NW0 link layer interface processor 120 or the NW1 link layer interface processor 121 and thereby discriminates or determines the session type of the packet. The term session mentioned here indicates a series of communications from the establishment of a communication connection to a communication disconnection or cutoff. The IP routing accelerator 140 discriminates the session type, based on information about a transmission source IP address, a destination IP address, a transmission source port number, a destination port number, a protocol type of a session layer, etc. contained in the received packet.

When it is discriminated that the session type obtained by analyzing the received packet is being stored in the transmission route information table 130, the IP routing accelerator 140 transmits the received packet to a packet transmission destination corresponding to the corresponding session type. On the other hand, when it is discriminated that the session type obtained by analyzing the received packet is not being stored in the transmission route information table 130, the IP routing accelerator 140 relays the received packet to the sequence controller 150 provided in a stage subsequent thereto.

The IP routing accelerator 140 transmits a transmit packet supplied from the sequence controller 150 to the communication network 200 or 201 via the NW0 link layer interface processor 120 or the NW1 link layer interface processor 121.

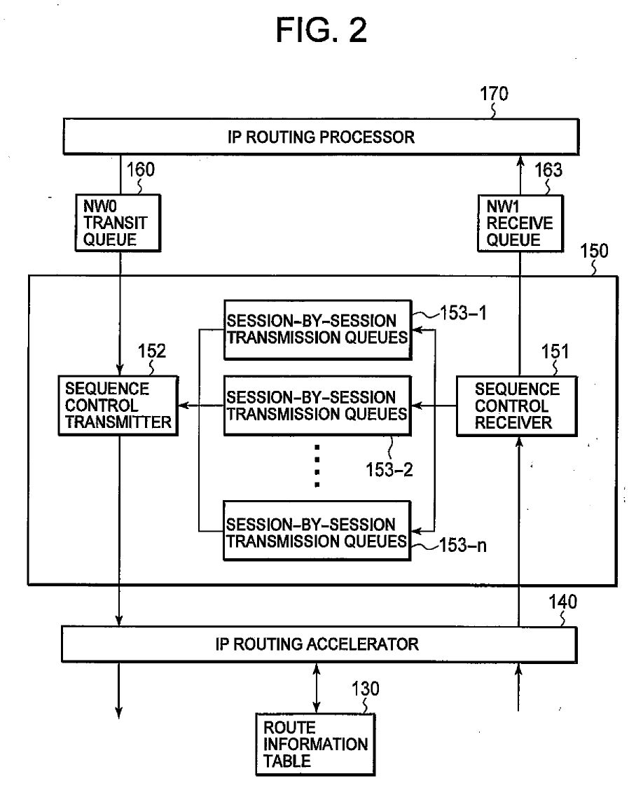

FIG. 2 is a block diagram showing the router device 100 in which the sequence controller 150 is represented in detail. Incidentally, the NW0 physical layer interface processor 110, the NW1 physical layer interface processor 111, the NW0 link layer interface processor 120, the NW1 link layer interface processor 121, the NW0 transmit queue 160 and the NW1 receive queue 163 are not shown in the same figure.

A sequence control receiver 151, the sequence control transmitter 152 and session-by-session transmission queues 153-1 through 153-n (where n: positive integer) used for relaying packets from the communication network 201 to the communication network 200 are shown in the sequence controller 150 in the same figure. Although blocks similar to these, for relaying packets from the communication network 200 to the communication network 201 are contained in the sequence controller 150, these blocks are not shown in the same figure.

The sequence control receiver 151 analyzes a received packet sent from the IP routing accelerator 140 to discriminate a session type of the received packet. The sequence control receiver 151 discriminates the session type, based on information about a transmission source IP address, a destination IP address, a transmission source port number, a destination port number, a protocol type of a session layer, etc. contained in the received packet. The sequence control receiver 151 retrieves a session-by-session transmission queue corresponding to the session type obtained by the above analysis from within the session-by-session transmission queues 153-1 through 153-n. When the session-by-session transmission queue corresponding to the session type could be retrieved, the sequence control receiver 151 adds the received packet to the backend of the session-by-session transmission queue and stores it therein. On the other hand, when the session-by-session transmission queue corresponding to the session type could not be retrieved, the sequence control receiver 151 newly generates a session-by-session transmission queue for storing or accumulating the received packet and gives the received packet to the IP routing processor 170.

When the session-by-session transmission queues 153-1 through 153-n are generated respectively, the sequence control receiver 151 generates session identification numbers unique or peculiar to the session-by-session transmission queues 153-1 through 153-n and associates the session-by-session transmission queues 153-1 through 153-n with them. The session identification numbers are of numbers which increase one by one from 0 in the generating order of session-by-session transmission queues 153-1 through 153-n, for example. The sequence control receiver 151 retrieves a session-by-session transmission queue corresponding to the session type of the received packet, based on each of the session identification numbers.

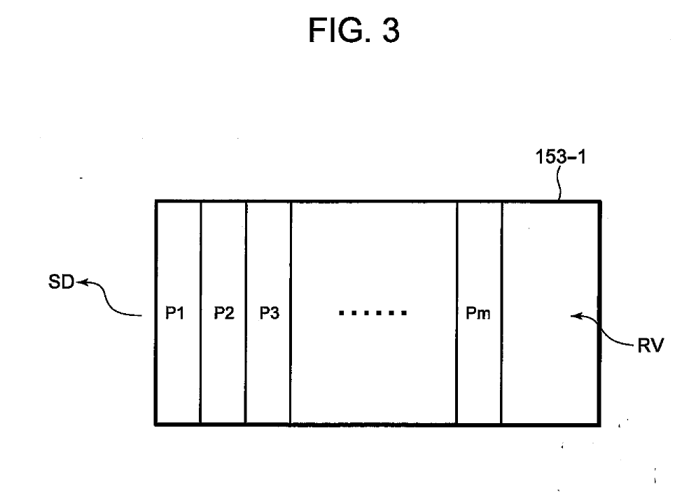

Each of the session-by-session transmission queues 153-1 through 153-n is of a packet storage or accumulation area generated within a memory (not shown) by the sequence control receiver 151. The session-by-session transmission queues 153-1 through 153-n accumulate or store received packets sent from the sequence control receiver 151 therein in their received order. FIG. 3 is a diagram showing the session-by-session transmission queue 153-1. The session-by-session transmission queue 153-1 accumulates received packets P1, P2, . . . , Pm (where m: positive integer) sent from the sequence control receiver 151 in their accepted order (symbol RV in the figure). The sequence control transmitter 152 to be described later fetches out the received packets P1, P2, . . . , Pm from the session-by-session transmission queue 153-1 in the order thereof (in accumulation order) (symbol SD in the figure). Each of the session-by-session transmission queues 153-2 through 1530n is also similar to the session-by-session transmission queue 153-1 in configuration. The session-by-session transmission queues 153-1 through 153-n are respectively associated with unique session identification numbers and store or accumulate received packets for sessions different from one another. When the total number of the received packets sent from the sequence control receiver 151 exceeds the number of packet accumulation limits, the session-by-session transmission queues 153-1 through 153-n respectively discard the received packets in accumulation order (old order).

The sequence control transmitter 152 analyzes each received packet sent from the IP routing processor 170 to discriminate a packet transmission destination set to the received packet and a session type of the received packet. The sequence control transmitter 152 discriminates a session type, based on information about a transmission source IP address, a destination IP address, a transmission source port number, a destination port number, a protocol type of a session layer, etc. contained in the received packet. The sequence control transmitter 152 associates the packet transmission destination and the session type obtained by the above analysis with each other and causes the transmission route information table 130 to store the same therein. Concurrently with it, the sequence control transmitter 152 retrieves a session-by-session transmission queue corresponding to the session type of the received packet, based on each of the session identification numbers from within the session-by-session transmission queues 153-1 through 153-n, takes or fetches out all received packets accumulated in the session-by-session transmission queue obtained by the retrieval, and gives these to the IP routing accelerator 140 in accumulation order (in order from the old packets) as transmit packets, from which they are transmitted.

The sequence control transmitter 152 discards all session-by-session transmission queues matched with session identification numbers smaller than the session identification numbers associated with the session-by-session transmission queues obtained by the retrieval. This is because when the IP routing processor 170 to be described next did not give a corresponding received packet to the sequence control transmitter 152, i.e., the session of the received packet is not targeted for relay, it prevents the received packet from remaining accumulated in the session-by-session transmission queue corresponding to the session.

The IP routing processor 170 discriminates based on the result obtained by analyzing the received packet sent from the sequence control receiver 151, whether the received packet is given to the sequence control transmitter 152. When it is discriminated at the IP routing accelerator 140 that the received packet can be subjected to routing processing, the IP routing processor 170 normally gives the received packet to the sequence control transmitter 152 for its relay. At this time, the IP routing processor 170 determines a packet transmission destination, based on the information about the transmission source IP address, destination IP address, transmission source port number, destination port number, protocol type of session layer, etc. contained in the received packet, set it to the received packet and gives it to the sequence control transmitter 152.

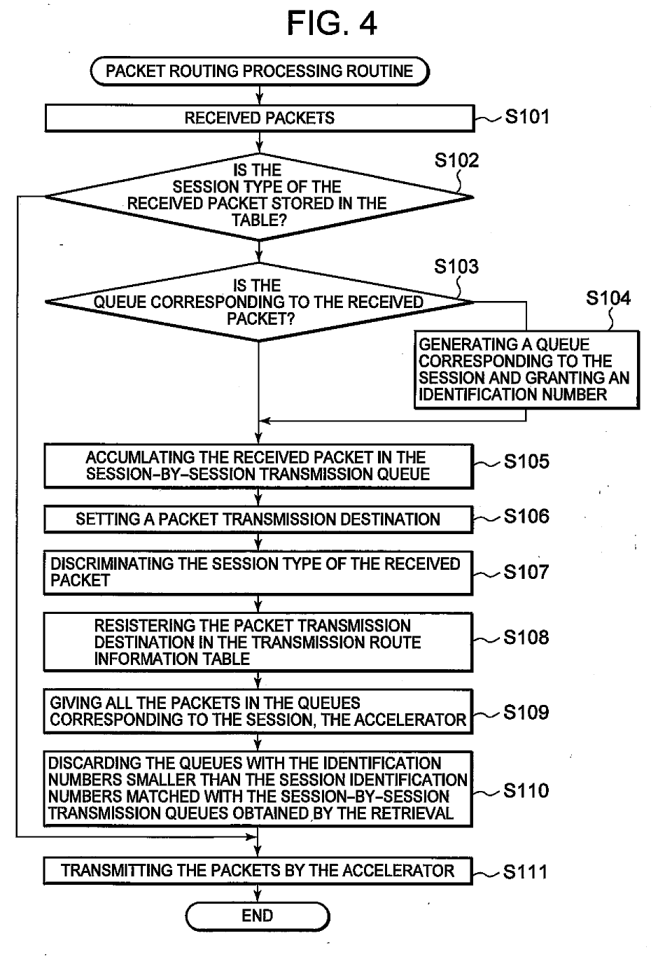

FIG. 4 is a flowchart showing a packet routing processing routine. Packet routing processing conducted by the router device 100 will be explained below with reference to FIG. 4.

The IP routing accelerator 140 first accepts a received packet from the NW0 link layer interface processor 120 or the NW1 link layer interface processor 121 (Step S101).

When it is discriminated that the session type obtained by analyzing the received packet is being stored in the transmission route information table 130, the IP routing accelerator 140 transmits the received packet to its corresponding packet transmission destination corresponding to the session type (Step S102). On the other hand, when it is discriminated that the session type obtained by analyzing the received packet is not being stored in the transmission route information table 130, the IP routing accelerator 140 relays the received packet to the sequence control receiver 151 provided in the stage subsequent thereto.

When the session-by-session transmission queue corresponding to the session type obtained by analyzing the received packet sent from the IP routing accelerator 140 could not be retrieved (Step S103), the sequence control receiver 151 newly generates a session-by-session transmission queue associated with a unique session identification number (Step S104), the sequence control receiver 151 supplies the received packet to the IP routing processor 170. On the other hand, when the session-by-session transmission queue corresponding to the session type obtained by analyzing the received packet sent from the IP routing accelerator 140 can be retrieved (Step S103), the sequence control receiver 151 accumulates the received packet in the session-by-session transmission queue (Step S105).

When it is discriminated that the IP routing accelerator 140 is capable of performing routing processing on each received packet sent from the sequence control receiver 151, the IP routing processor 170 sets a packet transmission destination to the received packet and gives the same to the sequence control transmitter 152 (Step S106).

The sequence control transmitter 152 analyzes each received packet sent from the IP routing processor 170 and thereby discriminates the packet transmission destination set to the received packet and the session type of the received packet (Step S107).

The sequence control transmitter 152 associates the packet transmission destinations and session types obtained by the above analysis with one another and registers them in the transmission route information table 130 (Step S108). Concurrently with it, the sequence control transmitter 152 retrieves session-by-session transmission queues each corresponding to the session type of each received packet from within the session-by-session transmission queues 153-1 through 153-n and thereby takes or fetches out all received packets stored in the session-by-session transmission queues obtained by the retrieval. Then, the sequence control transmitter 152 gives them to the IP routing accelerator 140 in accumulation order (in order from the old packets) as packets to be transmitted.

The sequence control transmitter 152 discards all session-by-session transmission queues associated with their corresponding session identification numbers smaller than the session identification numbers matched with the session-by-session transmission queues obtained by the retrieval (Step S110).

The IP routing accelerator 140 sequentially transmits all transmit packets sent from the sequence controller 150 to the communication network 200 or 201 via the NW0 link layer interface processor 120 or the NW1 link layer interface processor 121 (Step S111).

When the IP routing accelerator 140 has received other packets lying in the same session as the transmit packets supplied from the sequence controller 150 subsequently, the IP routing accelerator 140 performs routing processing on other packets, based on the correspondences between the packet transmission destinations and session types registered in the transmission route information table 130 by the sequence control transmitter 152 and transmits the same therefrom. Since all the received packets accumulated in the session-by-session transmission queue at Step S109 are being transmitted in accumulation order by the IP routing accelerator 140 before the transmission of other packets, the interchange of transmission order thereof in the same session does not occur.

According to the router device 100 according to the present embodiment as described above, the packet transmission destination and session type obtained by analyzing each received packet are registered in the transmission route information table 130 with being associated with each other and at the same time all received packets (all received packets in the same session as the received packet) accumulated in the session-by-session transmission queue corresponding to the session type of the received packet are transmitted. When the IP routing accelerator newly receives other packets in the same session as the received packet, all received packets accumulated in the session-by-session transmission queue have already been sent at the time that other packets are subjected to the routing processing, based on the information registered in the transmission route information table 130 and are transmitted. Therefore, the interchange of transmission order of packets in the same session does not occur. Thus, according to the router device 100 according to the present embodiment, the IP routing accelerator is capable of performing the routing processing on each received packet at high speed without causing the interchange of transmission order of the packets in the same session.

While the preferred form of the present invention has been described, it is to be understood that modifications will be apparent to those skilled in the art without departing from the spirit of the invention. The scope of the invention is to be determined solely by the following claims.

What is claimed is:

1. A router device comprising:
a transmission route information table for storing session types and packet transmission destinations therein in association with one another;
an IP routing accelerator for, when it is discriminated that a session type of each received packet is being stored in the transmission route information table, transmitting the received packet to a corresponding packet transmission destination corresponding to the session type, and relaying the received packet to a subsequent stage when it is discriminated that the session type is not stored in the transmission route information table;
a sequence control receiver for accumulating each received packet sent from the IP routing accelerator in each of session-by-session transmission queues each corresponding to the session type of the received packet;
an IP routing processor for setting a packet transmission destination to the received packet; and
a sequence control transmitter for causing the transmission route information table to store the packet transmission destination set to said each received packet and the session type of the received packet in association with each other and causing the IP routing accelerator to transmit all received packets accumulated in the session-by-session transmission queue corresponding to the session type of the received packet.

2. The router device according to claim 1, wherein each of the sequence control receiver and the sequence control transmitter includes session type discriminating means for discriminating the session type, based on at least one of a transmission source IP address, a destination IP address, a transmission source port number, a destination port number, and a protocol type of a session layer.

3. The router device according to claim 1, wherein the sequence control receiver includes session identification number associating means for associating each of the session-by-session transmission queues with a unique session identification number, and
wherein the sequence control transmitter includes session type discriminating means for discriminating session identification corresponding to the session-by-session transmission queue, based on the session identification number.
